(19) United States
(12) Patent Application Publication
(10) Pub. No.: US 2006/0098957 A1
(43) Pub. Date: May 11, 2006

(54) Data protective apparatus and method thereof

(75) Inventor: Jeong-Joo Jeong, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/983,611

(22) Filed: Nov. 9, 2004

(51) Int. Cl. H04N 5/781

(52) U.S. Cl. 386/125; 386/126

(57) ABSTRACT

A data protective apparatus for a hard disc drive (HDD) built in an optical recorder and player and a method thereof. The data protective apparatus includes a hard disc drive for storing latest refresh times and/or access times of stored files, a DVD-RAM drive, a flash ROM for storing an operating system for operating a system and application programs, and a control unit for reading the refresh times and/or access times of the respective files in the hard disc drive, comparing the refresh times and/or access times of the respective files with the present time, and refreshing and storing the files of which the refresh times and/or access times reach the present time. The data protective apparatus can preserve data such as videos, photographs, and music, recorded in the HDD for a long time period without damage, and enable a user to perform a backup of the data in a disc for the permanent preservation of the data.

### BACKGROUND OF THE INVENTION

1. Field of the Invention

The present invention relates generally to a data protective apparatus for an optical recorder and player having a built-in hard disc drive and a method thereof. More particularly, the present invention relates to a data protective apparatus for an optical recorder and player having a built-in hard disc drive (HDD) and a method thereof which can protect data by refreshing the data recorded in the HDD before performing a backup of the data to a disc or other storage devices in a digital video recorder (DVR) using DVD or HDD media.

2. Description of the Related Art

With the digitalization of broadcasting signals and the development of compression technology, the functions of a video recorder and player that can record a broadcasting signal in a recording medium or play the recorded broadcasting signal have been expanded. Such video recorder and players have been developed to support the use of diverse video sources such as satellite broadcasting signals, cable broadcasts, and network broadcasts through the Internet. With the digitalization of data and the development of compression technology, optical storage mediums, such as CD-ROMs or DVDs, are being used to store data. Since this optical medium causes very little picture deterioration, video data with high picture quality and multi-channel audio data (for example, 5.1 channels) can be stored in the optical medium. As a result, conventional analog video recording mediums are being rapidly replaced by the optical medium. The video recorder and player have independent functions of recording and playing various audio and video signals. For example, a DVD/HDD video recorder and player is constructed so that a DVD-ROM for playing data recorded on a disc and an HDD for recording and playing data are combined in a case. In this case, the DVD-ROM and the HDD has an interface for enabling them to perform mutual data transmission and reception as they independently perform their own functions. Generally, the DVD-ROM is provided to perform the playback of data recorded in an optical disc recording medium such as a DVD, audio CD, video CD, MP3 CD, and the like. The DVD/HDD video recorder and player may record data of the received broadcasting signal in the HDD or record data readout from the DVD-ROM in the HDD.

Current video recorder and players may include a memory card, IEEE1394 DV, USB, and the like to store a moving image or still image taken by a digital camera in the HDD. Since optical medium such as DVDs store a large amount of video and audio data (typically in the range of several hundred Mbytes to several Gbytes) the video recorder and player usually includes a hard disc driver that is a mass storage device for making it easy to store or read large amounts of data.

Accordingly, the capacity of HDDs have continuously increased. Consequently, the management of the video data recorded in a large-capacity HDD is very important since the recorded information may be damaged if management thereof is not periodically performed. The damage of data occurs not only due to an external shock or a driving software error, but also due to the non-access of the data for long periods of time. If the stored data is not accessed for a long period of time, the magnetic force that keeps the recorded information on the tape becomes weak, and it begins to lose the recorded information. As a result of research and analysis of recording medium, the HDD has a typical wear-out time of 3 to 5 years. This means that if about three years elapses while the HDD is in a state that the access of the stored data is not periodically performed, the data integrity cannot be secured. If the information recorded in the HDD is left without continual read and/or write operations, the possibility of data loss becomes high. Accordingly, important information recorded in the HDD such as photographs, videos, and the like, to be preserved for a long time, may be damaged to such an extent that the user cannot recognize it.

### SUMMARY OF THE INVENTION

The present invention has been developed in order to solve the drawbacks discussed above and other problems associated with the conventional arrangement as well as to provide other advantages. An aspect of the present invention provides a data protective apparatus for a hard disc drive (HDD) built in an optical recorder and player and a method thereof which can substantially reduce the possibility of loss of recorded data such as videos or photographs stored in the HDD, and preserve the data for a long period of time by automatically performing a periodic data check and enabling a user to perform a backup of the data.

The foregoing and other aspects and advantages are substantially realized by providing a data protective apparatus for a hard disc drive, according to an embodiment of the present invention, which comprises the hard disc drive for playing stored data or storing external data in a recordable area, and storing the latest refresh times and/or access times of stored files, a DVD drive for playing or storing video and/or audio data, a flash ROM for storing an operating system for operating a system and application programs, and a control unit. The control unit reads the refresh times and/or access times of the respective files in the hard disc drive, compares the refresh times and/or access times of the respective files with the present time, and refreshes and stores the files for which the refresh times and/or access times equals the present time.

In embodiments of the present invention, the flash ROM further stores a data backup warning message in a graphic user interface (GUI) form. When the control unit refreshes and stores the files for which the refresh times equal the present time, it simultaneously controls the flash ROM to output the warning message for a data backup and controls the system to store the refreshed files in a disc.

In another embodiment of the present invention, the refresh is performed through reading of a specified amount of data to be refreshed or performing defragmentation. To achieve the above aspect, a method is provided according to an embodiment of the present invention for protecting the data of a hard disc drive of a combo type video recorder/player having a built-in DVD player and hard disc drive comprising the steps of determining the latest refresh times and/or access times of files stored in the hard disc drive, comparing the refresh times and/or access times with the present time, and refreshing the files if the refresh times and/or access times of the corresponding files equals the present time.

According to embodiments of the present invention, the step of refreshing the files further comprises refreshing and storing data of the files to be refreshed by reading a specified amount of data to be refreshed or performing defragmentation, outputting a necessary message for performing a backup of the files to be refreshed, and storing the files in a disc.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram illustrating the construction of a DVD/HDD combo system having a DVD player and a hard disc drive according to an embodiment of the present invention;

FIG. 2 is a flowchart illustrating a process of protecting data stored in a hard disc drive according to an embodiment of the present invention;

FIG. 3 is a view illustrating an example of a backup message being displayed according to an embodiment of the present invention; and

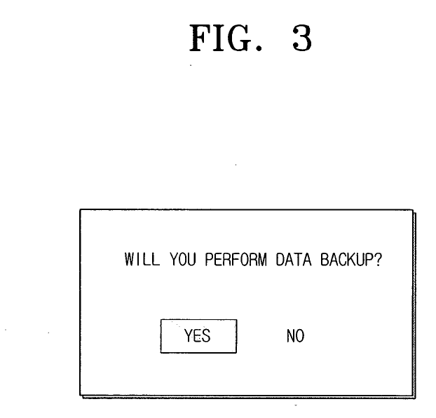

FIG. 4 is a view illustrating a physical data structure of a hard disc drive according to an embodiment of the present invention.

### DETAILED DESCRIPTION OF THE EXEMPLARY EMBODIMENTS

Certain embodiments of the present invention will be described in greater detail with reference to the accompanying drawings. In the following description, the same drawing reference numerals are used for the same elements throughout the drawings. The matters defined in the description such as a detailed construction and elements are the ones provided to assist in a comprehensive understanding of the invention. Thus, it is apparent that the present invention can be carried out without those defined matters. Also, well-known functions or constructions are omitted for purposes of conciseness.

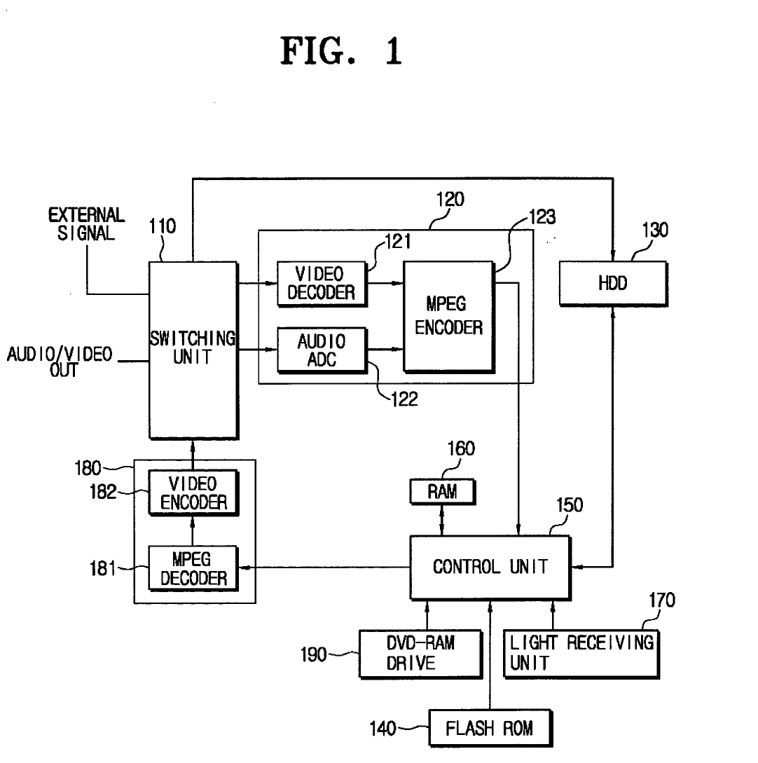

FIG. 1 is a block diagram illustrating the construction of a DVD/HDD combo system having a DVD player and a hard disc drive according to an embodiment of the present invention.

Referring to FIG. 1, the DVD/HDD combo system according to an embodiment of the present invention has a switching unit 110, an MPEG encoder unit 120, a hard disc drive (HDD) 130, a flash ROM 140, a control unit 150, a RAM 160, a light-receiving unit 170, a digital signal processing unit 180 and a DVD-RAM drive 190. The HDD 130 is but one member of a class of devices known as long term memory devices, that can also include read/write-able compact discs, memory sticks, external and internal tape drives, as well as other devices. Throughout this description, the term “HDD 130” will be used, but will be meant to incorporate all the types of devices referred to as above as long term memory devices.

The switching unit 110 receives diverse external video and audio data from a ground-wave analog tuner, external input device, set top box (STB), or video data output from a decoder unit for use with a monitor. The switching unit 110 receives the external signal as described above, and selectively applies the external signal to a function block in the video recorder and receiver. For example, if the external signal applied from the outside is either a component video signal or a composite video signal, the switching unit 110 applies this signal to the MPEG encoder unit 120.

The MPEG encoder unit 120 includes a video decoder 121, an audio analog-to-digital converter (ADC) 122 and an MPEG encoder 123. The MPEG encoder unit 120 converts a video signal applied from the switching unit 110 into digital video data, and compresses the video data into an MPEG format (for example, MPEG-2 format). Typically, video data of the MPEG format is in a compressed form so as to reduce its size when it is stored in a storage medium such as the HDD 130.

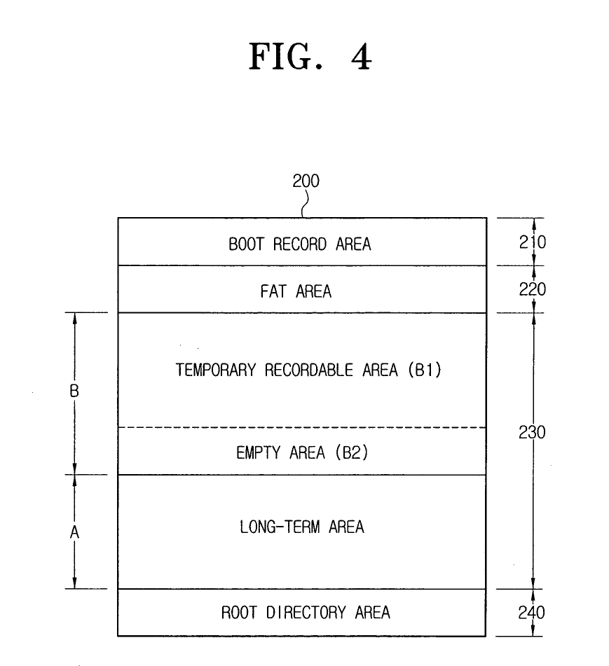

The HDD 130 stores video data and audio data having the MPEG format in a data recordable area in the form of a file. With reference to FIG. 4, the physical data structure of the HDD will now be explained.

The data structure of the HDD includes a boot record area 210, a file allocation table (FAT) ( ) area 220, a data recordable area 230 and a root directory area 240.

The boot record area 210 is an area where information about the physical structure of the HDD 200, such as information about a drive partition, is recorded.

The FAT area 220 is an area of the HDD 200 where state information is recorded regarding the position of clusters of the data recordable area 230 data subject to recording. A cluster is a recording unit composed of at least two sectors, and a large amount of data is divided and recorded in a plurality of clusters. However, even if a file is divided and recorded in several clusters, these clusters need not be arranged in succession, but can be sporadically positioned in different locations within the HDD. In this case, the positions of the clusters related to the corresponding file are arranged and managed in the FAT. Typically a defragmentation function is performed to increase the storage efficiency of the HDD. This rearranges the clusters using the FAT.

The data recordable area 230 is an area where the data subject to recording is actually recorded, and is classified into a long-term recordable area A and a non-recorded area B.

The long-term recordable area A is a non-volatile recordable area for filing and recording the data subject to recording (for example, audio and video signals) for a long period of time in accordance with a recording command from a user. The file of the data to be recorded for a long period of time can be edited according to the desires of the user.

The non-recorded area B is an area where no data is recorded. A temporary recordable area B1 is adaptively allocated to the non-recorded area for a time-shift viewing function (hereinafter referred to as a “time shift function”), and the remaining area, is an empty area B2.

The temporary recordable area B1 is allocated to a part of the non-recorded area B so that a program being received can be temporarily recorded. The amount of data that can be stored in the temporary recordable area B1 preferably corresponds to the recording for approximately “one hour”. If a selected buffer time refers to “Auto”, the temporary recordable area B1 is allocated to the whole of the non-recorded area B so that the program being received can be temporarily recorded in the non-recorded area B for as much capacity as exists in the non-recorded area B. If the selected buffer time refers to “Off”, the temporary recordable area B1 is not allocated at all, and thus the program being received is not temporarily recorded.

If the program being currently played is temporarily being recorded in the allocated temporary recordable area B1, the position information of the initial cluster where the program being played is temporarily recorded (that is the recording start position of the temporary recordable area B1) is recorded in the root directory area 240. Also, if a long-term recording command is input with respect to the program temporarily recorded in the temporary recordable area B1, the corresponding program is recorded for a long term in the long-term recordable area A in available clusters.

The root directory area 240 is an area where attribute information, position information of the long-term-recorded data or temporarily recorded data in the data recordable area 230 is recorded. The attribute information of the file created by the control unit 150 includes general file management information. The general file management information includes a file name or title name of the data subject to recording, file capacity, recorded and refreshed date and time, and the position information that includes a recording start address and a recording end address of the data subject to recording. Whenever an editing operation such as recording, refreshing and deletion of the file is performed, the state information of the FAT area 220, attribute information and position information of the root directory area 240 are refreshed.

The flash ROM 140 stores an operating system for operating the HDD 130 and the DVD-RAM drive 190 and application programs. The application programs are for displaying on a screen the video and audio data stored in the HDD 130 in the form of a file and their additional information (such as an icon, title name, recording time, file size, and backup message) through a menu in the form of a graphic user interface (GUI). The application programs also provide for editing and displaying the video and audio data stored in the HDD 130 through the displayed menu.

The control unit 150 stores the MPEG data output from the MPEG encoder unit 120 in the HDD 130, or provides the video and audio data stored in the HDD 130 to the digital signal processing unit 180. In the case of playing the DVD, the control unit 150 reads out information about a DVD title from information about a disc information file area and records the information in the root directory area of the HDD 130. The control unit 150 also reads out the related GUI menu information from the flash ROM 140 and displays the GUI menu so as to display the icon and title name. The icon and title name corresponds to the video data stored in the HDD 130 in the form of a file on the display screen. The icon and title name is displayed by executing the application program stored in the flash ROM 140. If the mode of the system is a stop mode, the control unit 150 reads the recording or refreshing time for every file from the file management information of the HDD 130. If there is any file to be refreshed, it performs the refresh operation and outputs the backup message using the displayed GUI menu.

The memory (RAM) 160 loads the file stored in the HDD 130 when the control unit 150 edits the file. The file stored in the HDD 130 is not directly edited, but is edited in the memory (RAM) 160 and restored in the HDD 130.

The light-receiving unit 170 receives a control signal (not illustrated) generated from a remote controller (not illustrated) for controlling the video recorder and player. Such controls can include a channel change, volume control, and picture quality adjustment, or a setting key (not illustrated) provided in the video recorder and player, and provides the control signal to the control unit 150.

The digital signal processing unit 180 receives the video data of the MPEG format stored in the HDD 130 via the control unit 150, decodes the video data and then converts the decoded data into a video format (for example, NTSC/PAL). The converted signal can be played through a video display appliance such as a television receiver.

The DVD-RAM drive 190 reads out the video and audio data from the disc and provides the readout video and audio data to the control unit 150. The DVD-RAM drive 190 also stores the video and audio data provided to the control unit 150 in the HDD 130 or provides the video and audio data to the digital signal processing unit 180 to play the video and audio data. Also, the DVD-RAM drive stores the video and audio data input from the outside and the data of the HDD 130 in the disc under the control of the control unit 150.

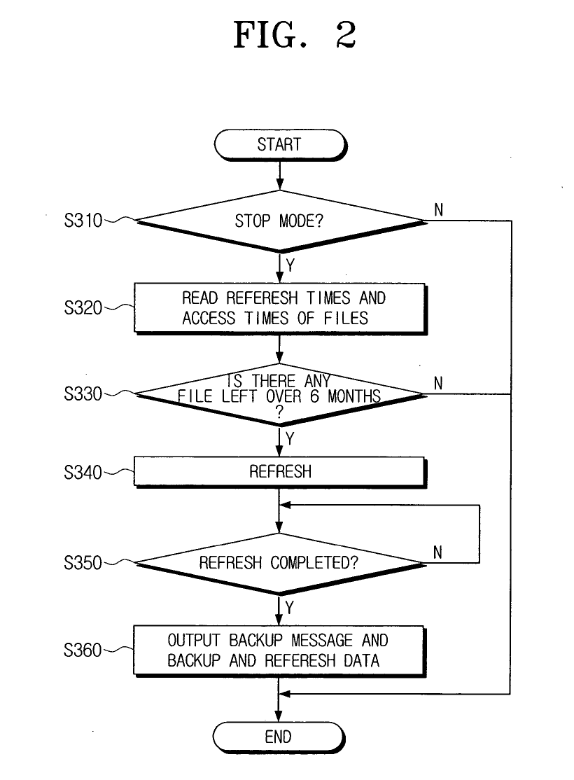

Hereinafter, the data protective method for a HDD according to an embodiment of the present invention will be explained with reference to FIG. 2.

FIG. 2 is a flowchart illustrating a process of protecting data stored in the HDD 130 according to an embodiment of the present invention.

The control unit 150 judges whether the system mode is a stop mode in order to refresh the stored data at decision step S310. Although the currently described embodiment of the present invention exemplifies that the refresh function is performed only when the system is in the stop mode, it will be apparent that it is possible to perform the refresh function irrespective of the mode in a composite system using a plurality of control units. If it is judged that the present mode is the stop mode at decision step S310 (“Yes” path from decision step 310), the control unit 150 reads the final refresh times and access times of the respective files stored in the HDD 130 at step S320, and judges whether there is any file that is left over a period of 6 months by comparing the readout time with the present time of the system at decision step S330. If the system mode is the stop mode, the control unit 150 reads out the final refresh times and access times of the respective files from the root directory area 240 of the HDD 130, and compares the readout refresh times and access times with the present time to find the files that have not been refreshed or accessed over a period of 6 months (hereinafter referred to as a “refresh period”). If there is a file that has been stored for a period of time greater than the refresh period (“Yes” path from decision step 330), the control unit 150 refreshes the file at step S340. This is for the user to display and read the file so as to prevent the data of the file that is left for a long term from being damaged. In this case, the refresh is performed through reading of a predetermined amount of data, or through performing of defragmentation is the file is small. If the refresh is completed at decision step S350 (“Yes” path from decision step 350), the control unit 150 controls the display device to display the related GUI menu read from the flash ROM 140 so that the user can store the data stored in the HDD 130 in the disc for a long term. If the user selects the backup function, the control unit 150 controls the system to store the related file in the disc and simultaneously refreshes the final refresh time of the corresponding file existing in the root directory area 240 of the HDD 130 at step S360. If the present mode is not the stop mode at step S310 (“No” path from decision step 310), or if there is no file that is left over a period of 6 months at decision step S330 (“No” path from decision step 330), the control unit 150 terminates the data protective procedure. Accordingly, the data can be preserved without damage.

As described above, the data protective apparatus and method according to the embodiments of the present invention, preserves data, such as videos, photographs, music, and the like, recorded in the HDD, for a long time period without damage. Also, by displaying a warning message to a user before the stored data is damaged, the user can perform a backup of the data in a disc to preserve the data for a long time period.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A data protective apparatus for a long term memory storage device built in an optical recorder and player, comprising:
the long term memory storage device for playing stored data or storing external data into a recordable area, and storing latest refresh times and/or access times of stored files;
a control unit for reading the refresh times and/or access times of the respective files in the long term memory device, comparing the refresh times and/or access times of the respective files with the present time, and refreshing and storing the files of which the refresh times and/or access times are substantially equal to the present time.

2. The data protective apparatus as claimed in claim 1, wherein the long term memory storage device comprises a hard disc drive.

3. The data protective apparatus as claimed in claim 1, further comprising:
a DVD-RAM drive for playing or storing video and/or audio data.

4. The data protective apparatus as claimed in claim 1, further comprising a flash ROM for storing an operating system for operating a system and application programs and storing a data backup warning message in a graphic user interface (GUI) form,
wherein the control unit refreshes and stores the files of which the refresh times are substantially equal to the present time, simultaneously controls the flash ROM to output the warning message for a data backup and stores the refreshed files in a disc.

5. The data protective apparatus as claimed in claim 1, wherein the refresh is performed through reading of a specified amount of data to be refreshed or performing defragmentation.

6. The data protective apparatus as claimed in claim 1, wherein the control unit reads and compares the refresh times and/or access times of the files with the present time if the optical recorder and player is in a stop mode.

7. The data protective apparatus as claimed in claim 1, wherein the refresh is performed if a difference between the refresh times and/or access times of the files and the present time corresponds to a period of at least about 6 months.

8. The data protective apparatus as claimed in claim 1, wherein the final refresh times and/or access times of the respective files are stored in a root directory area of the hard disc drive.

9. A method for protecting data in a long term memory device of an optical video recorder and player, comprising the steps of:
judging latest refresh times and/or access times of files stored in the long term memory device;
comparing the refresh times and/or access times with the present time; and
refreshing the files if the refresh times and/or access times of the corresponding files are substantially equal to the present time.

10. The method as claimed in claim 9, wherein the step of refreshing the files further comprises:
refreshing and storing data of the files to be refreshed by reading a specified amount of data to be refreshed or performing defragmentation;
outputting a necessary message for performing a backup of the files to be refreshed; and
storing the files in the long term memory storage device.

11. The method as claimed in claim 9, wherein the step of refreshing the files comprises:
reading a specified amount of data to be refreshed or performing defragmentation.

12. The method as claimed in claim 9, wherein the step of judging latest refresh times comprises:
reading and comparing the refresh times and/or access times of the files with the present time if the optical recorder and player is in a stop mode.

13. The method as claimed in claim 9, wherein the refreshing step is performed if a difference between the refresh times and/or access times of the files and the present time corresponds to a period of at least about 6 months.

14. The method as claimed in claim 9, wherein the final refresh times and/or access times of the respective files are stored in a root directory area of the hard disc drive.

15. The method as claimed in claim 9, wherein the long term memory storage device comprises a hard disc drive.

16. The method as claimed in claim 9, wherein the optical recorder and player further comprises:
a built in DVD-RAM drive.
